(19) United States
(12) Patent Application Publication
(10) Pub. No.: US 2026/0079880 A1
(43) Pub. Date: Mar. 19, 2026

(54) Three-Dimensional Modular Asynchronous Parallel Computer and Methods of Construction Therefor

(71) Applicant: Massachusetts Institute of Technology, Cambridge, MA (US)

(72) Inventors: Zachary Peter Fredin, Cambridge, MA (US); Neil Gershenfeld, Cambridge, MA (US); Lauren Camron Blackburn, Somerville, MA (US); Amira Abdel-Rahman, Boston, MA (US); Erik Steven Strand, Cambridge, MA (US); Jiri Zemanek, Prague (CZ)

(73) Assignee: Massachusetts Institute of Technology, Cambridge, MA (US)

(21) Appl. No.: 17/369,451

(22) Filed: Jul. 7, 2021

Related U.S. Application Data
(60) Provisional application No. 63/050,061, filed on Jul. 9, 2020.

(51) Int. Cl. G06F 15/80

(52) U.S. Cl. CPC G06F 15/803

(57) ABSTRACT

A computer system consists primarily of identical modular microcontroller units, interconnecting with one another in a three-dimensional lattice. During operation, each microcontroller communicates asynchronously by relying on token-passing between itself and its neighbors. Programming and construction of such microcontroller units occurs in one operation, through robotic pick-and-place operations that are configured through a graphical user interface. The graphical user interface includes simple drag and drop operations to facilitate a WYSIWYG depiction of the desired build and the final system. The design tools and automated assembly of the disclosed framework introduces system scalability and structural flexibility that are not available with existing supercomputing racks and chassis.

### CROSS-REFERENCE TO RELATED APPLICATION

This application claims priority to U.S. provisional patent application No. 63/050,061, filed Jul. 9, 2020. The contents of the '061 application are hereby incorporated by reference in their entirety.

### GOVERNMENT FUNDING STATEMENT

This invention was made under contract with DARPA and the Air Force Research Laboratory under award number F8650-19-2-7921. The government has certain rights in the invention.

### FIELD OF THE INVENTION

The present invention relates generally to integrated circuits and more particularly to a system of discrete integrated circuit electronics. The present invention also relates to parallel computing structures composed of modular building blocks that communicate asynchronously, and methods of construction of such computing structures.

### BACKGROUND AND DESCRIPTION OF THE PROBLEM SOLVED

### I. Introduction

There is a familiar hierarchy from developing chips, to packages, to boards, to blades, to systems. Different skills are required for design at each layer, and different industries perform their production. We present an alternative to this prevailing paradigm, DICE (Discrete Integrated Circuit Electronics). DICE is based on the three-dimensional assembly of computational building blocks that can span these levels of description. It extends the role of modularity from design to construction, with a direct-write process using a cross between pick-and-place and 3D printing.

The immediate antecedent to DICE is the assembly of chips from chiplets [1]. These can offer very high interconnect speed and density, but are limited to two-dimensional chip-scale applications. DICE takes advantage of progress in packaging, fabrication, and automation to offer an architecture that spans from devices to systems, with acceptable performance overhead as described below. A closer antecedent is older, the post-war Project Tinkertoy that aimed to robotically assemble electronics from standard building blocks [2]. DICE revisits that goal with updated components and unexpected results, as Project Tinkertoy could not have contemplated the functional and performance expansions of final finished systems when composed of modular computing units (rather than 1950's-era electronics).

Potential benefits of DICE include reducing the time and cost for system development, aligning applications with architectures, shortening and reducing vulnerabilities in supply chains, reducing waste with disassembly rather than disposal, and enabling greater system integration and novel form factors.

Realizing these benefits requires revisiting the historical boundary between hardware and software, in order to simultaneously specify the content and construction of a computation. What is needed is an end-to-end DICE workflow, including performance projections (for existing and prospective devices), modules (on multiple length scales), their programming (both embedded and application), assembly (using conventional and custom robots), design (both logical and physical placement), and applications (aligning geometry and algorithms for machine learning and high-performance computing).

### II. Objects of the Invention and Relevant Projections

It is an object of the invention to provide a new computing system consistent with the principles of DICE, as well as a system and method for the construction of DICE computing systems. As background, it is helpful to calculate projections of DICE performance before discussing their implementation. Table I compares the speed, power, and cost efficiency of existing and potential DICE devices with other computing platforms to illustrate their potential impact. Assuming a low communication overhead, supported by experimental benchmarking and analysis further explained within the detailed discussion of the preferred embodiments, it would take roughly 3,000 SAMD51 microcontroller DICE nodes to match the compute performance of an Intel Core i7, and the DICE network would require about 30% more power. The same comparison using NXP RT1020 microcontrollers would need approximately 1,000 nodes and consume half of the power of the i7.

TABLE I
DICE PERFORMANCE PROJECTION AND COMPARISON

| | GFlops | GFlops/W | GFlops/$ | W | | $ |
|---|---|---|---|---|---|---|
| Summit ORNL^{(a)} | 148,600,000 | 14.7 | 0.45 | 10,096 | kW | $325MM |
| Nvidia V100^{(b)} | 12,589 | 50.4 | 2.10 | 300 | W | $5993 |
| Intel i7-8700T^{(c)} | 46.9 | 0.34 | 0.155 | 140 | W | $537 |
| SAMD51J20A^{(c)} | 0.0168 | 0.233 | 0.01 | 72 | mW | $2.91 |
| NXP i.MX RT1020^{(c)} | 0.0417 | 0.593 | 0.02 | 70 | mW | $1.87 |
| “Summit MCU”^{(d)} | 1 | 14.7 | 0.45 | 68 | mW | $2.22 |
| Super-DICE^{(d)} | 5 | 10⁶ | — | 10 | nW | — |

^{(a)}November 2019 Green500 list [3]
^{(b)}Manufacturer's specification.
^{(c)}Flops and power measured with a pi calculation benchmark [4]
^{(d)}Projected calculations for dedicated DICE hardware.

Looking beyond commercial-off-the-shelf (COTS) components, DICE has the potential to scale to state-of-the-art supercomputing performance with a dedicated node modeled after the Summit supercomputer's power and cost efficiency [3]. The Qualcomm Hexagon DSP processor has been shown to achieve a maximum power efficiency of 58 mW/GHz on an architecture with 256 KB of RAM, two 32 bit ALUs, two 64 bit vector execution units, and an asynchronous FIFO bus interface [5]. Taking this as a starting point, one can envision replacing the logic units with single precision FPUs shown to have 1.44 mW power consumption without significant additional cost [6]. Combining these low-power techniques, it appears feasible to develop a DICE node capable of single-cycle floating-point operations at 1 GHz while consuming 68 mW with a cost of $2.22. Named here the “Summit MCU” due to matching its 14.7 GFlops/W and 0.45 GFlops/$, this part would enable DICE to become a competitive high performance embedded system where just 50 nodes would outperform the Intel Core i7 while using 97% less power.

Development of rapid single flux quantum (RSFQ) superconducting electronics is limited by their cryogenic cooling overhead and a maximum of 0 (104) Josephson junctions per computing unit due to bias current in the circuit [7]. DICE provides a promising solution for these limitations by building complex computing from simple low gate-count nodes and making better use of cryogenic refrigerator volumes with its 3D scaling. It has been shown that 8-bit superconducting ALUs can operate at 5 Ghz with 1.4 aJ power dissipation [8]. Extrapolating this to a custom Super-DICE ASIC, a chip with 0 (104) Josephson junctions operating at 5 GHz would require roughly 10 nW per operation. Taking into account the 103 W/W overhead for 4K cooling, superconducting DICE would perform at 106 GFlops/W, a 105 power efficiency improvement over state-of-the-art supercomputing.

### SUMMARY OF THE INVENTION

Consistent with the foregoing background and objects, a computer system consists primarily of identical modular microcontroller units, interconnecting with one another in a three-dimensional lattice. During operation, each microcontroller communicates asynchronously by relying on token-passing between itself and its neighbors.

Programming and construction of such microcontroller units occurs in one operation, through robotic pick-and-place operations that are configured through a graphical user interface. The graphical user interface includes simple drag and drop operations to facilitate a WYSIWYG depiction of the desired build and the final system.

Once the desired configuration is complete, construction starts with a single user instruction to begin. During the pick-and-place construction operation, the robotic arm first places each to-be-added microcontroller onto a flash pad for programming of its particular code. Then the robotic arm performs the physical addition and connection of the microcontroller to the lattice.

Applications for such computer systems include physics particle simulation, wherein each microcontroller represents and maintains memory and performs calculations for a single particle. Lead connections to edge modules can perform external I/O operations to feed data and obtain results, with intra-lattice communications operating solely via the above-mentioned asynchronous token passing.

### BRIEF DESCRIPTION OF THE FIGURES

FIG. 1 depicts an example assembly of eleven microcontroller modules formed into a DICE lattice.

FIG. 2 depicts fifteen microcontroller modules connected in a cluster on a build plate with an external supply and instrumentation.

FIG. 3 depicts the arrangement of FIG. 2 after reaching steady state running a pi calculation benchmark, viewed through a long-wave IR thermography camera.

FIG. 4 depicts twelve rendered Meso-DICE nodes and struts assembled to form a 2×2×3 lattice.

FIG. 5 depicts four functional Meso-DICE test elements assembled and powered on.

FIG. 6 depicts an assembler, with the workpiece in front, the stack of parts in the back, and the programming station on the right.

FIG. 7 depicts example screens of the graphical design tool for the assembler, with interchangeable windows to enable the simultaneous design of software and hardware, as well as assembly and testing in real time.

FIG. 8 depicts additional example screens of the graphical design tool for the assembler, with interchangeable windows to enable the simultaneous design of software and hardware, as well as assembly and testing in real time.

### DETAILED DESCRIPTION OF THE PREFERRED EMBODIMENTS

The present invention is a computing system and methods for construction of the computing system, where the system in final form is a three-dimensional lattice of physically similar modules that communicate asynchronously with each other using token exchange. The construction method includes a graphical user interface that sets up a pick-and-place robotic arm operation where the robotic arm movement includes placement of a module onto a flash pad for programming prior to attachment to the growing workpiece.

### Modules

Based on the preceding projections, DICE modules were developed with COTS components to demonstrate an end-to-end workflow rather than ultimate performance limits. A core element of DICE is the directed physical assembly of computational elements which are programmable to suit both planned and unexpected applications. Interconnection between elements supports the transfer of information, power, and mechanical loads, and must be durable enough to permit repeated re-assembly [9], whether by hand or by purpose-built machine.

Prior to developing dedicated DICE devices, a number of general-purpose microcontrollers were considered for prototyping the workflow. The search space was limited to devices with floating-point units (FPUs), since planned applications would require this capability. Microcontrollers were further evaluated based on estimated performance (net and per watt), along with minimum available package size, RAM, and built-in communication peripherals. FPGAs were also considered as they would allow considerable flexibility in terms of internode communication implementation and problem-specific gate configurations [10], but were avoided for these initial iterations due to space concerns and lack of direct portability with existing applications. Based on this evaluation, and the availability of a well-documented, open development toolchain [11], the Microchip SAMD51J20 ARM Cortex M4F microcontroller was selected for initial prototyping of a general-purpose DICE computing module, with more specialized heterogeneous modules anticipated to follow.

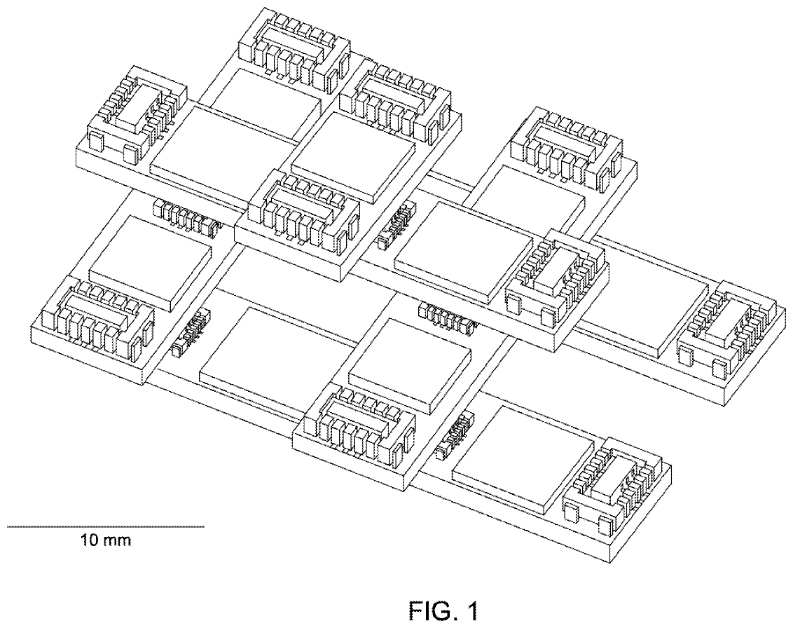

Initially, two hardware iterations were designed and tested in parallel. The first design, called Static-DICE, was not mechanically reconfigurable, but rather was intended to quickly provide a network of elements large enough to develop and test inter-node communication layers. Given von Neumann neighbors [13] (i.e Cartesian connections only, or four interconnections per node), a minimum of twelve nodes were needed if laid out in a two-dimensional grid. Four additional nodes were added to the final design, forming a square 4×4 grid with sixteen elements. The second design, called Tiny-DICE (see FIG. 1), consisted of mechanically reconfigurable modules capable of tiling with four neighbors per node. Tiny-DICE was used to study the practical limits of commercially available hardware, both in terms of size (using the smallest parts possible) and suitability for mechanical assembly (as small-scale board-to-board connectors are typically not designed for parallel configurations or structural use). As with Static-DICE, Tiny-DICE used Microchip SAMD51J20 processors, this time in 3.5×3.6 mm wafer-level chip-scale-package (WLCSP) format. Power, information, and mechanical interconnection was provided by 6-pin Molex SlimStack [14] mezzanine-type connectors. As is evident from the depiction of FIG. 1, the board of each Tiny-DICE module comprises a top and a bottom, the microcontroller is on the top and interconnected with two socket mezzanine connectors, while the bottom comprises two pin mezzanine connectors interconnected with the microcontroller. The orientation of the top connectors is perpendicular to that of the bottom connectors, thus resulting in the tiling possibility depicted in FIG. 1, wherein alternate layers assemble perpendicularly. Note as well how, when connected, the bottom connectors are able to join two boards at the edges of neighboring top connectors. The small ball pitch on the WLCSP microcontroller necessitated a commercially sourced high density interconnect PCB with six layers, 100 μm traces, and blind vias. Final node dimensions of 4.5×9.0 mm were driven by the connector and processor size. Board outline tolerances were below manufacturer capabilities, so PCB edge routing was performed in-house on a precision CNC mill prior to automated component placement and reflow soldering. After verifying solder joint integrity using X-ray inspection, a spring contact programmer was fabricated to flash Tiny-DICE nodes with test code.

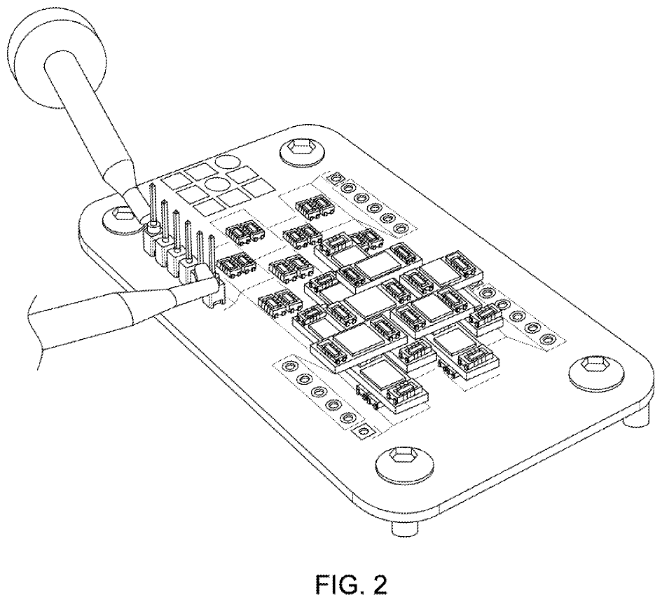

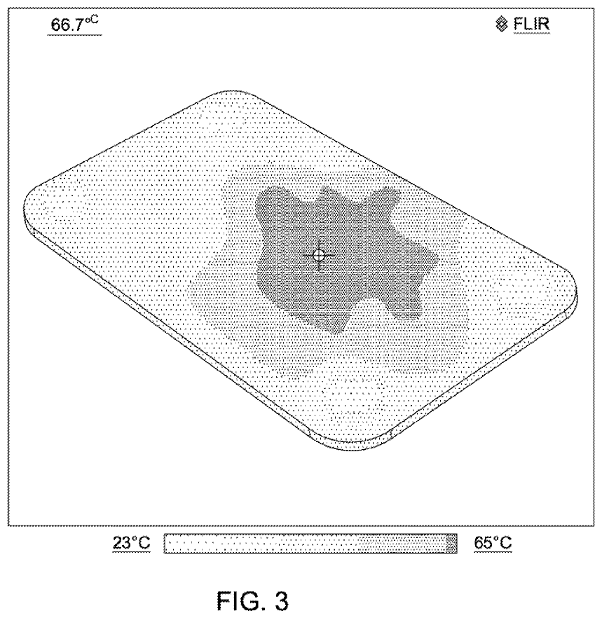

Tiny-DICE devices were evaluated for power consumption, computation, and thermal performance as a fifteen-node cluster on a build plate as shown in FIG. 2. Each device was programmed with a simple pi calculation benchmark [4] set to run for one million iterations. Power consumption was measured using a current shunt and an oscilloscope, and the results compared to other hardware devices as shown in Table I. Thermal results are shown graphically in FIG. 3.

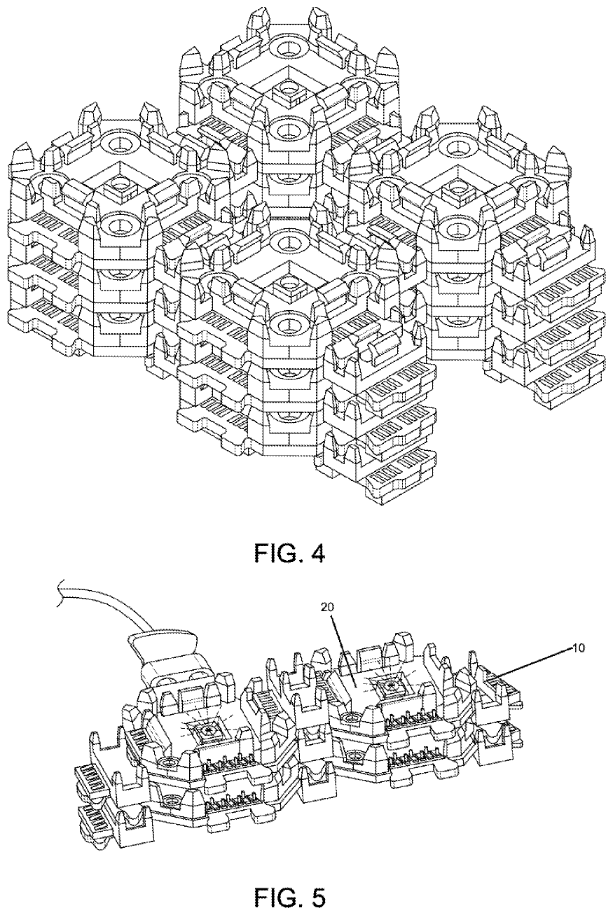

Lessons from both Static-DICE and Tiny-DICE informed a third hardware iteration, called Meso-DICE, shown in FIGS. 4 and 5. These devices are intended to quickly demonstrate the complete workflow, from design tools through automated assembly, application execution, and mechanical reconfiguration. To simplify construction and assembly mechanics, the hardware is scaled roughly to Static-DICE proportions, and includes fabricated mechanical features to self-align and latch nodes together. Meso-DICE elements tile in a simple cubic lattice with six neighbors; to ease assembly, passive strut elements 10 link adjacent nodes 20 using COTS spring terminals. As with Tiny-DICE, a spring contact programmer was fabricated to simplify firmware development.

### Assembly

Two approaches were evaluated for automating DICE assembly. For the larger Meso-DICE parts, end-effectors were developed for use in a Universal Robots UR10 arm. And for the Tiny-DICE parts, a dedicated machine was developed that is a cross between a pick-and-place and a 3D printer. The purpose of this automatic assembler is to build a physical structure according to the layout created in the DICE design tool. The machine picks Tiny-DICE parts from a stack to place them to the final positions. The build process starts with putting the parts on the substrate; the next layer is then placed on top of the modules on the substrate, and so on. Optionally, before the deposition, the assembler can put every part into the programming station to load firmware with a bootloader that allows later updates.

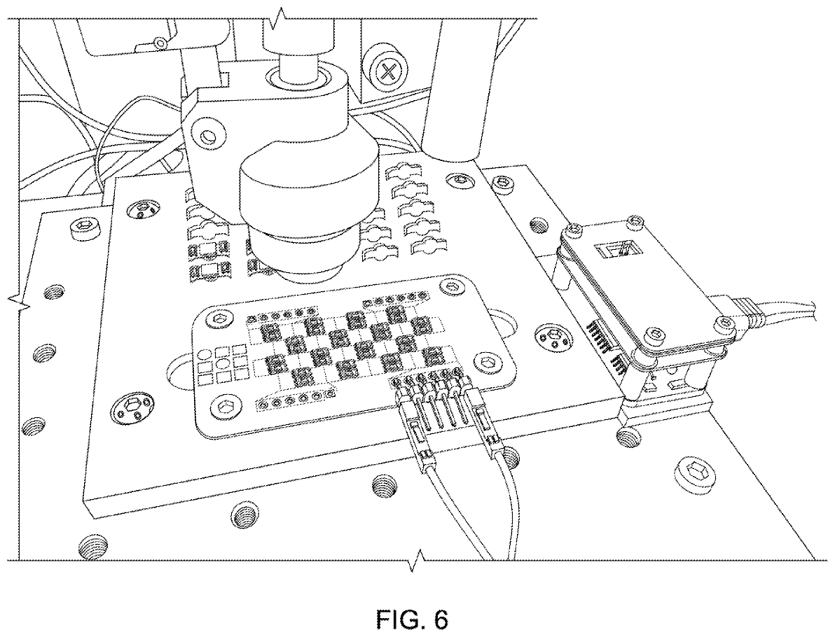

The Tiny-DICE assembler (FIG. 6) has a standard XYZ configuration with a rotational axis on the tool head. The assembler frame is machined from steel reinforced HDPE and aluminum. To limit friction, all axes use polymer linear guideways. XY axes are driven by standard stepper motors NEMA-17 with GT2 timing belt and Z-axis by a non-captive stepper motor with a leadscrew. A control board receives G-code commands from a computer and drives the motors with a resolution of 5 μm (possible repeatability is approximately 50 μm) and max speed 50 mm/s. The assembler also has an on-tool USB microscope that allows precise jogging and optical registration.

To reduce the size as much as possible, the Tiny-DICE parts have no features to facilitate assembly, and due to dense packing of the final assembly, the space for grabbing of parts is limited. Therefore, the assembler utilizes a pair of mating SlimStack connectors to attach the part to the tool head. An extendible pin actuated by a linear servo (with max force of 35 N) is then used to release the part from the tool head and place it to the final destination.

Successful testing occurred with built structures of several layers. Limiting factors are the self-aligning capabilities of the connectors and the absence of mechanical support under upward-facing connectors on Tiny-DICE parts. Therefore, the successful placing of parts relies on the rigidity of the connection between already placed parts.

### Design

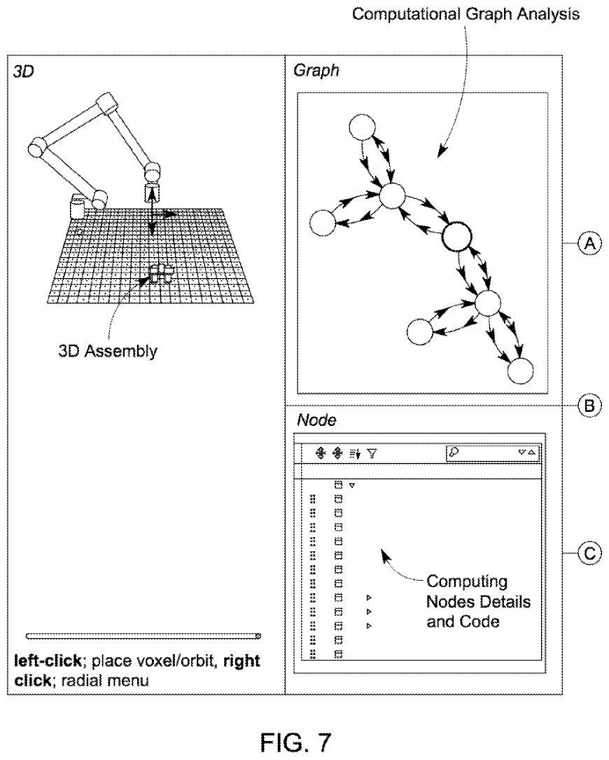

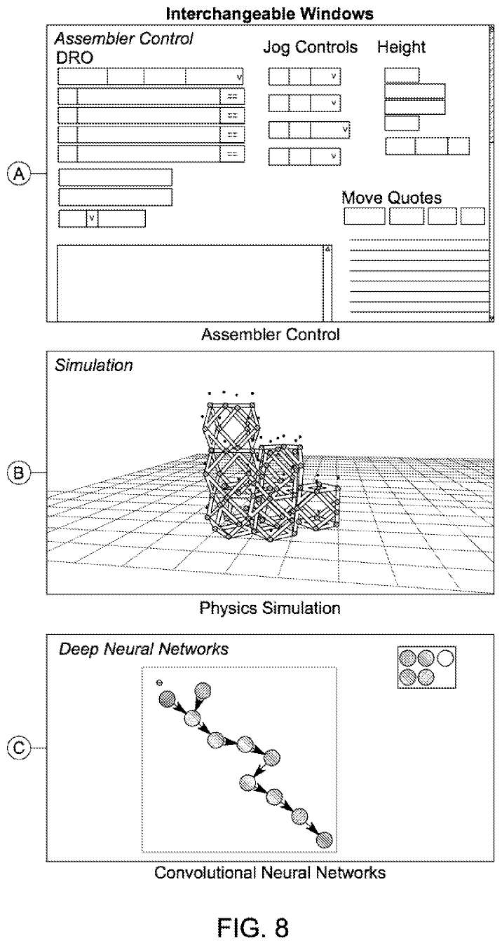

Traditional electronics design workflows follow a sequential linear process that starts with design, then analysis and simulation, and finally system fabrication and testing. Often these stages are executed independently from each other, using different tools, making it hard to translate the feedback from the simulation or testing stages into viable design amendments. This adds considerable inefficiency to an inherently iterative design workflow. As an alternative, the present invention optionally includes an integrated, closed loop DICE design tool that allows one to design, simulate, optimize and fabricate re-configurable computing systems (see FIGS. 7 and 8).

The design workflow of the present invention follows several steps. Persons of ordinary skill in the art of user interfaces, robotic G-code, computation theory, and flash programming for microcontrollers would find the following features to be well within their respective skill sets to construct, once provided with the following description.

First, on screen, DICE nodes are placed (FIG. 7) to visualize the 3D structure of the computing system. The user then selects individual nodes to specify details, such as processor type, connected neighbors, program, number of operations, maximum token size, and so forth. During these steps, a connectivity graph is generated in real-time, showing the average computation and communication cost of each node based on these preprogrammed node details. It would be within the level of ordinary skill in the art for these numbers alternatively to be automatically calculated by pre-compiling and profiling code for each node.

By treating the computation graph as a flow network, graphical algorithms are used to find and highlight computation and communication bottlenecks. Based on this analysis, design recommendations are generated and displayed, including suggestions for different processors, extra nodes, or alternative routing.

If the user wants to further optimize the reconfigurable computing system, the performance projection graph tool visualizes the effect of each hardware and software decision on projected overall system performance. A generative probabilistic programming model is used to draw samples from these inputs and project the cost, energy use, and speed of the system. Using classic inference techniques, one may infer the optimal hardware configuration for a given software workflow. In the future this could be extended to additionally perform hardware architecture discovery.

After optimization, the simulation window allows the user to visualize the state and output of the DICE computation. Currently, this shows the output of a simulated computation provided on the host computer prior to physical assembly. In the future, this framework can be used to visualize data from the DICE network.

In parallel with the previous steps, the real-time assembly control window provides a simple mechanism for controlling the mechanical DICE assembler. Using this feature, systems can be fabricated, programmed, and tested in real-time to quickly pull in feedback and amend the system architecture accordingly.

This novel integrated design workflow paves the way for the design of both discretely integrated circuits and reconfigurable computing systems that can change and evolve during execution as needed.

### APPLICATION

### Programming Model

The DICE programming model emphasizes the physical locality of both memory and compute resources. By reflecting the underlying compute hardware, this strategy facilitates reconfigurability, scalability, and energy efficiency. As a result, applications must be implemented with distributed algorithms that operate on distributed data. This requires a different set of tools than is conventionally used for writing parallel code.

Synchronization and communication between DICE nodes is achieved via the transfer of tokens. Tokens carry arbitrary data payloads and have application defined identifiers. DICE nodes can check for the presence or absence of a token with a certain identifier from a certain neighbor. Tokens are exchanged only between neighboring nodes, so if data is to be passed between physically separated nodes it must be passed along a chain of intermediate nodes to get there.

Conceptually, DICE nodes can be viewed as actors that process and exchange these tokens. Input and output data of computations are passed around as token payloads, and each DICE node greedily performs computations as inputs become available. Currently this model is implicit in the application codes discussed below. Future versions will employ a domain specific language that associates tokens with actions explicitly, ceding the main loop to the DICE runtime environment and allowing it to invoke actions as their tokens become available.

Comparison with Existing Models

In the sense that DICE networks consist of regularly arranged data processing units, they are similar to systolic arrays [15]. However for DICE there need not be consistent directions of data transfer, and the complexity of the data and computations handled by each node is typically higher.

DICE networks are similar to Petri nets in that they produce and consume tokens along a graph [16]. However, DICE networks impose a consistent lattice structure on the graph, and allow arbitrary data payloads to be associated to the tokens. It is also more common for connections between DICE nodes to be bidirectional than in Petri nets. In a similar manner, DICE networks resemble asynchronous logic automata (ALA) [17], [18], where ALA's single bit tokens are replaced with DICE's arbitrary payloads, and ALA's boolean algebra operations are replaced with DICE's arbitrary computations.

In Flynn's taxonomy [19], each DICE node is a SISD computer. A network of DICE nodes is a MIMD computer. Future implementations could include SIMD or MIMD nodes, in the form of multi-core processors, FPGAs, or more massively parallel processors akin to GPUs.

### Implementation

For the existing SAMD51-based prototype nodes, the DICE programming model and runtime environment is implemented as a C/C++ library organized into three layers. The first layer is a hardware abstraction layer that interfaces with the SAMD51's peripherals. In particular, a full implementation of the firmware stack requires use of the generic clock controller (GCLK), nested vector interrupt controller (NVIC), external interrupt controller (EIC), and the universal synchronous and asynchronous receiver and transmitter (SERCOM USART). The second layer is a data link layer that enables transfer of raw bytes between neighboring nodes. It serves an analogous purpose to the data link layer in the OSI model [20]. The third layer is the token layer, which implements the token passing model described above.

### Physical Simulation

DICE lends itself to problems which can be subdivided via local data parallelism. One such problem is physical simulation, which is also a leading use of national class supercomputers. Here, we describe a generalized discrete element method (DEM) simulation for DICE.

Each DICE node is responsible for simulating a certain region of space [21]. Adjacent regions within the simulation are computed by adjacent DICE nodes. As particles move between these regions, their data is transferred between the corresponding nodes. Computationally, each node computes local interaction forces between particles, and uses these forces to integrate the particles' velocities and positions forward in time. Particles near region boundaries may interact across them, requiring some data transfer.

Within each DICE node, the memory required to store particle data and the computational effort required to compute interaction forces are both proportional to the volume of the simulated region. The data that must be transferred between nodes, however, is proportional to the surface area of the region. Thus the overhead of communication between nodes is reduced as the size of the regions simulated by each node grows. A critical factor for performance is the density of interacting particle pairs, since the calculation of interaction forces dominates compute time. In practice this density is limited by an interaction cutoff distance. Even for the existing generation of SAMD51J20 based nodes, the projected communication overhead is not prohibitive. Each SAMD51 has 256 KB of RAM, can be clocked at 120 MHz, and has six SERCOMs that can each transmit a maximum of three million bits per second. Given these constraints, and assuming an interaction cutoff distance of three times the characteristic particle spacing at maximum density, a single node can store approximately 1,700 particles. At maximum capacity, each node would compute ˜135,000 interaction forces in ˜1.3 seconds. Computing these forces would require transferring ˜200 KB of particle data between each node and its neighbors, which would take ˜85 ms if all six SERCOMs are used in parallel. Thus if data transmission and force computation happen serially, about 6% of each DICE node's time would be spent transferring data. In practice data transmission and computation can be overlapped to a degree using DMA.

The Summit MCU discussed earlier would enable much greater performance. In particular, with 1 GFLOPS and 256 KB of RAM, each node could compute its particles' interaction forces in ˜16 ms. To keep the communication overhead manageable, the Summit MCU's SERCOMs should be proportionately faster than the SAMD51's. In particular, with six 128 MBit/s SERCOMs, each node could transfer the necessary particle data in ˜2 ms. This would result in each node spending ˜11% of its time transferring data, assuming no overlap with computation.

### Machine Learning

Another important application for DICE is to create reconfigurable computing systems for machine learning. Deep Neural Networks (DNNs) are currently used in countless applications, and through time, the models are becoming deeper and more sophisticated. In an attempt to benchmark and compare the training performance of variably sized and shaped DNNs on different hardware architectures (CPUs, GPUs or TPUs), its was concluded that there were no winners [22]. TPUs had the highest throughput and worked best with large batches, GPUs were more flexible for small problems and irregular computations, and CPUs were the most programmable and were the only ones to support larger models [22]. There is an increased need for accelerators and application-specific hardware in order to reduce data movement, one of the main bottlenecks of deep learning training, without compromising accuracy, throughput and cost [23].

Consequently, joint hardware/software design workflows are essential for developing a deep learning system, where spatial computing architectures are tailored to the depth and shape of the DNNs, as well as to the size of the training data. This will minimize the data movement and shared memory access, which dominates the energy consumption in traditional computing architectures.

As a first step to address this problem, a machine learning add-on was implemented as part of the integrated physical computing design tools (see FIG. 8). There, one may choose and add different kinds of DNN layers and specify their size, activation function, and parallelism strategy. The add-on also has a real-time graphical visualization of the training progress showing the updated accuracy of the model though time.

In order to benchmark and estimate the computing requirements for DICE to train DNNs, AlexNet, a Convolutional Neural Network (CNN), is widely used for benchmarking hardware. It was the first CNN to win the ImageNet challenge [24]. AlexNet consists of five convolutional (CONV) layers and three fully connected (FC) layers. For a 227×227 input image, it requires 61M weights and 724M multiply-and-accumulates (MACs). Similar to most DNN architectures, the FC layers have significantly more weights than CONV layers (58.6M vs 2.3M) and CONV layers are more computationally expensive than FC layers (666M MACs vs 58.6M MACs).

Assuming complete data parallelism, a number of challenges arise when naively trying to map AlexNet onto a DICE system that uses only one type of node (the SAMD51 processor prototype). Since each processor has only 256 Kb of RAM, for FC layers, one might need up to 2300 nodes just to store the weights and perform the calculations, which will result in a communication overhead of more than 1600%. Therefore, specialized node types are required to efficiently map AlexNet, or any DNN, into a DICE architecture in an effort to minimize data movement, maximize number of parallel computations, and minimize the number of idle nodes. One is to design hierarchical memory allocation and access. Dedicated memory nodes could store data (filters, weights or input images) which is hierarchically broadcast based on the layer architecture. This enables temporal and spatial data reuse, where the data is read only once from the expensive memory and is sent to the small local cheap memory for reuse. Moreover, the number of weights stored and computation performed can be pruned by introducing specialized nodes that address the sparsity generated when using the ‘ReLU’ as an activation function. For example, AlexNet's layers have around 19-63% sparsity. This has proven to reduce the energy cost by 96% using similar spatial architecture hardware [25]. If these changes were implemented, in addition to using the projected Summit MCU instead of the SAMD51, the computation speed will increase by 85× and the average communication overhead for FC layers will decrease to 33%.

Even though the performance of the first generation DICE demonstration for deep learning applications does not outperform current specialized HPC architectures, advances in Internet of Things and embodied computing require computation to be physically near sensors and data collection devices in order to minimize large data transfer. The modularity and ease of assembly of DICE will facilitate this system integration along with specialized robotic and electro-mechanical input and output modules for data collection, actuation and output visualization.

Furthermore, one key aspect of DICE modules is their reconfigurability; this means that in addition to changing the hardware modules to fit different types of networks, one can reconfigure the hardware itself as a system learns. Recent research in deep learning is developing dynamic DNNs that not only optimize their weights but also their structure, which means that the hardware should be optimized to match at different stages of the training. This reconfigurability will also be essential for online learning and probabilistic inference tasks where the computing architecture grows as more data are presented or more analysis is needed.

### CONCLUSION

The DICE framework provides a novel approach to system architecture for high performance computing. As power consumption and memory bandwidth continue to limit Exascale system development [26], DICE blends a low-power node architecture, distributed memory hierarchy, 3D packaging, and intuitive design implementation to align hardware with software.

Beyond the potential raw compute power of DICE nodes detailed in section I, the design tools and automated assembly of the DICE framework introduces system scalability and structural flexibility that are not available with existing supercomputing racks and chassis. Building a custom supercomputer or expanding an existing cluster requires rework of middle layer code and complicated compiler optimizations [27]. This development bottleneck is bypassed in DICE due to its direct mapping between programming logic and spatial computing. Furthermore, the 3D packaging of DICE nodes and their unique interconnect design allows myriad physical configurations with potential for sparse lattice structures to optimize cooling overhead or structural elements for robotic design.

DICE introduces a new paradigm for high performance parallel computing which realigns the relationship between design, assembly, and architecture to seamlessly transition from logic to construction, and lays the groundwork for significant HPC power gains with future dedicated device development.

Several descriptions and illustrations have been presented to aid in understanding the present invention. One with skill in the art will realize that numerous changes and variations are possible without departing from the spirit of the invention. Each of these changes and variations is within the scope of the present invention, which is limited only by the appended claims.

### REFERENCES

[1] S. K. Moore, “Chiplets are the future of processors: Three advances boost performance, cut costs, and save power,” IEEE Spectrum, vol. 57, no. 5, pp. 11-12, 2020.
[2] R. Henry, “Project tinkertoy: a system of mechanized production of electronics based on modular design,” IRE Transactions on Production Techniques, vol. 1, no. 1, pp. 11-11, 1956.
[3] [Online]. Available: https://www.top500.org/green500
[4] N. Gershenfeld, The Nature of Mathematical Modeling. Cambridge University Press; 1st edition, November 1998.
[5] M. Saint-Laurent, P. Bassett, K. Lin, B. Mohammad, Y. Wang, X. Chen, M. Alradaideh, T. Wernimont, K. Ayyar, D. Bui, D. Galbi, A. Lester, M. Pedrali-Noy, and W. Anderson, “A 28 nm dsp powered by an on-chip ldo for high-performance and energy-efficient mobile applications,” IEEE Journal of Solid-State Circuits, vol. 50, no. 1, pp. 81-91, 2015.
[6] A. A. Del Barrio, N. Bagherzadeh, and R. Hermida, “Ultra-low-power adder stage design for exascale floating point units,” ACM Trans. Embed. Comput. Syst., vol. 13, no. 3s, March 2014. [Online]. Available: https://doi.org/10.1145/2567932
[7] I. I. Soloviev, N. V. Klenov, S. V. Bakurskiy, M. Y. Kupriyanov, L. Gudkov, and A. S. Sidorenko, “Beyond moore's technologies: operation principles of a superconductor alternative,” Beilstein Journal of Nanotechnology, vol. 8, p. 2689-2710 December 2017. [Online]. Available: http://dx.doi.org/10.3762/bjnano.8.269
[8] N. Takeuchi, T. Yamae, C. L. Ayala, H. Suzuki, and N. Yoshikawa, “An adiabatic superconductor 8-bit adder with 24kbt energy dissipation per junction,” Applied Physics Letters, vol. 114, no. 4, p. 042602, 2019. [Online]. Available: https://doi.org/10.1063/1.5080753
[9] W. K. Langford, “Electronic digital materials,” Master's thesis, Massachusetts Institute of Technology, 2014. [Online]. Available: http://cba.mit.edu/docs/theses/14.08.Langford.pdf
[10] R. Amerson, R. J. Carter, W. B. Culbertson, P. Kuekes, and G. Snider, “Teramac-configurable custom computing,” in Proceedings IEEE Sym-posium on FPGAs for Custom Computing Machines, 1995, pp. 32-38.
[11] ARM, “Gnu toolchain,” Accessed on: Jun. 19, 2020. [Online]. Available: https://developer.arm.com/tools-and-software/open-source-software/developer-tools/gnu-toolchain/gnu-rm
[12] Microchip, “Atsamd51j20a 32-bit sam microcontrollers,” Accessed on: Jun. 18, 2020. [Online]. Available: https://www.microchip.com/wwwproducts/en/ATSAMD51J20A
[13] A. W. Burks, “Von neumann's self-reproducing automata,” University of Michigan Technical Report, 1969.
[14] Molex, “Slimstack board-to-board connectors,” Accessed on: Jun. 18, 2020. [Online]. Available: https://www.molex.com/molex/products/family/slimstack_fine_pitch_smt_board_to_boar d_connectors
[15] H. Kung and C. E. Leiserson, “Systolic arrays (for vlsi),” in Sparse Matrix Proceedings 1978, vol. 1. Society for industrial and applied mathematics, 1979, pp. 256-282.
[16] J. L. Peterson, “Petri nets,” ACM Computing Surveys (CSUR), vol. 9, no. 3, pp. 223-252, 1977.
[17] D. Dalrymple, N. Gershenfeld, and K. Chen, “Asynchronous logic automata.” in Automata, 2008, pp. 313-322.
[18] N. Gershenfeld, D. Dalrymple, K. Chen, A. Knaian, F. Green, E. D. Demaine, S. Greenwald, and P. Schmidt-Nielsen, “Reconfigurable asynchronous logic automata: (rala),” SIGPLAN Not., vol. 45, no. 1, January 2010. [Online]. Available: https://doi.org/10.1145/1707801.1706301
[19] M. J. Flynn, “Some computer organizations and their effectiveness,” IEEE transactions on computers, vol. 100, no. 9, pp. 948-960, 1972.
[20] J. D. Day and H. Zimmermann, “The osi reference model,” Proceedings of the IEEE, vol. 71, no. 12, pp. 1334-1340, 1983.
[21] S. Plimpton, “Fast parallel algorithms for short-range molecular dynamics,” Sandia National Labs., Albuquerque, NM (United States), Tech. Rep., 1993.
[22] Y. E. Wang, G.-Y. Wei, and D. Brooks, “Benchmarking tpu, gpu, and cpu platforms for deep learning,” ar Xiv preprint arXiv:1907.10701, 2019.
[23] V. Sze, Y.-H. Chen, T.-J. Yang, and J. S. Erner, “Efficient processing of deep neural networks: A tutorial and survey,” Proceedings of the IEEE, vol. 105, no. 12, pp. 2295-2329, 2017.
[24] A. Krizhevsky, I. Sutskever, and G. E. Hinton, “Imagenet classification with deep convolutional neural networks,” in Advances in neural information processing systems, 2012, pp. 1097-1105.
[25] Y.-H. Chen, T. Krishna, J. S. Erner, and V. Sze, “Eyeriss: An energy-efficient reconfigurable accelerator for deep convolutional neural networks,” IEEE journal of solid-state circuits, vol. 52, no. I, pp. 127-138, 2016.
[26] S. Gibson, “Revisiting the 2008 exascale computing study at scl8,” HPC Wire, Nov. 29, 2018. Accessed on: Jun. 15, 2020). [Online]. Available: https://www.hpcwire.com/2018/1 1/29/revisiting-the-2008-exascale-computing-study-at-sc18/
[27] E. M. Arvanitou, A. Ampatzoglou, N. Nikolaidis, A. Tsintzira, A. Am-patzoglou, and A. Chatzigeorgiou, “Investigating trade-offs between portability, performance and maintainability in exascale systems,” in 46th Euromicro Conference on Software Engineering and Advanced Applications (SEAA 20), 08 2020.

We claim:

1. A computing system comprising a plurality of substantially identical modules, each module interconnecting to at least one other neighbor module to form a three-dimensional lattice, wherein each module communicates with neighbor modules by sending and receiving tokens, and wherein each module consumes said tokens for processing asynchronously.

2. The computing system of claim 1, wherein the plurality of substantially identical modules comprise microcontrollers to perform all computing functions.

3. The computing system of claim 2, wherein each of the plurality of substantially identical modules comprises a microcontroller placed onto a board, interconnected on said board to at least one mezzanine-type connector, whereby the mezzanine connectors facilitate module-to-module connection.

4. The computing system of claim 3, wherein each module comprises sufficient mezzanine connectors to tile with four other modules.

5. The computing system of claim 4, wherein the board of each module comprises a top and a bottom, the microcontroller is on the top and interconnected with two socket mezzanine connectors, while the bottom comprises two pin mezzanine connectors interconnected with the microcontroller.

6. The computing system of claim 5, wherein the mezzanine connectors comprise 6-pin socket and pin connectors.

7. The computing system of claim 1, wherein each module contains application code allowing it to simulate the physical behavior of a specific plurality of physical particles in a particle space, and to compute interaction forces therebetween.

8. The computing system of claim 8, wherein the specific plurality is a quantity up to a limit of approximately 1,700.

9. The computing system of claim 1 wherein each module consumes said tokens for processing immediately upon receipt.

10. The computing system of claim 2, wherein each of the plurality of substantially identical modules comprises a microcontroller node, each said microcontroller node electrically interconnected to at least one passive strut, whereby the struts facilitate module-to-module connection.

11. The computing system of claim 10 wherein the passive struts comprise interconnections, the interconnections comprise spring terminals, and the nodes self-align onto one another and onto the spring terminals.

12. The computing system of claim 11, wherein each module comprises sufficient strut interconnections to tile with six other modules.
